(19) United States
(12) Patent Application Publication
(10) Pub. No.: US 2007/0069043 A1
(43) Pub. Date: Mar. 29, 2007

(54) Piezoelectric liquid injector

(75) Inventor: Erwin Bogner, East Quogue, NY (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: Axial Vector Engine Corporation, Portland, OR (US)

(21) Appl. No.: 11/506,755

(22) Filed: Aug. 17, 2006

Related U.S. Application Data
(60) Provisional application No. 60/709,082, filed on Aug. 17, 2005.

(51) Int. Cl. B05B 3/04

(52) U.S. Cl. 239/102.2; 239/135; 239/68; 239/69; 239/74; 239/584

(57) ABSTRACT

A fuel or liquid injector includes a needle valve and a piezoelectric actuator that bears a hydraulic acceleration piston on its distal end. The actuator expands moving the piston toward the needle valve. The needle valve has a ball end, restrained against the valve seat by a spring, sealing the valve until the spring force is overcome by mechanical and hydraulic forces on the piston. When closed, the piston rests against the needle valve. Expansion of the piezoelectric actuator mechanically actuates the piston, and then increases the hydraulic pressure, which closes the fuel check valve, and accelerates the forward movement of the piston attached to the needle valve. When the restraining force on the needle valve is overcome, the ball end of the needle valve is unseated, and compressed fluid in the lower hydraulic chamber is released in a high velocity spray.

### CROSS REFERENCE TO RELATED APPLICATION

This application claims the benefit of the earlier filing of U.S. Provisional Application No. 60/709,082 filed on Aug. 17, 2005 incorporated herein in its entirety.

### FIELD OF THE INVENTION

The present invention relates generally to liquid injectors for use in supplying pressurized liquids. More particularly, the present invention relates to a liquid injector for use in supplying pressurized liquid, which injector is piezoelectrically actuated.

### BACKGROUND

Standard fuel injectors, including piezoelectric actuated fuel injectors, are designed to inject a given amount of fuel at very high pressures for good atomization of the fuel. Existing fuel injectors inject fuel at various points in the Otto cycle. Various approaches have been used to achieve a homogenous air and fuel mixture. Fuel injected during the intake stroke is typically injected into the intake air stream, not directly into the combustion chamber. The fuel is injected either in sequential sprays or in a single injection close to top dead center. Late injection of fuel does not induce a lot of mixing, resulting in uneven combustion. To compress fuel to very high pressures (up to 200 bar or 20 MPa) requires very high energy, and time. A standard in-tank fuel pump has an exit pressure of 1 to 2 bar (0.1 to 0.2 MPa). To achieve a 100 bar (10 MPa) standard fuel rail pressure requires a big fuel pump and a lot of power. The fuel has to be compressed further in the fuel injector to reach the final injection pressure of about 200 bar (20 MPa), achieved in existing fuel injectors.

### SUMMARY OF THE INVENTION

It is an object of the present invention to provide a high velocity, high frequency fuel injector, which is electrically actuated and has various electronically controlled flow rates.

It is a further object of the present invention to provide a high frequency fuel injector, which has various electronically controlled flow rates, and can handle multiple fuels (e.g., Diesel, JP8 and JP5).

It is a further object of the present invention to provide such a high frequency fuel injector, which is scalable, and small and lightweight.

It is yet another object of the present invention to provide such a high frequency fuel injector, which is piezoelectric actuated, and has the ability to inject very small amounts of fuel as well as greater amounts of fuel required at full power.

The fuel injector of the present invention is simple to build, easy to assemble, and simple to calibrate; yet is able to handle high compression rates for late injection, and to disperse the fuel into particles 12 Microns or smaller.

These objects, as well as other objects which will become apparent from the discussion that follows, are achieved, in accordance with the present invention, which comprises a piezoelectric liquid injector, which comprises a needle valve disposed within a housing so as to define at least two hydraulic chambers, each with a fluid inlet. The needle valve is contained in the housing by a proximal retaining cap, attached to an outer sleeve, attached to the main fuel injector body, comprising means of attachment to e.g., a fuel rail, with the distal end extending into a combustion chamber. The injector further comprises a piezoelectric actuator the proximal end of which is contained by a piezo end cap, secured within the retaining cap. The piezoelectric actuator bears a hydraulic acceleration piston on its distal end. Upon the application of a controlled voltage, the actuator expands, moving the piston through the upper hydraulic chamber toward the proximal end of the needle valve and the lower hydraulic chamber. The lower end of the needle valve comprises a ball end, restrained against the valve seat by a spring, sealing the valve until the restraining force of the spring is overcome by the mechanical and hydraulic forces on the piston at the proximal end of the needle valve. In its closed position, the piston rests against the proximal end of the needle valve. Expansion of the piezoelectric actuator mechanically actuates the hydraulic acceleration piston, and then increases the hydraulic pressure in the upper hydraulic chamber, which closes the fuel check valve, and accelerates the forward movement of the fuel accelerator piston, attached to the near the proximal end of the needle valve. When the restraining force on the needle valve is overcome, the ball end of the needle valve is unseated, and compressed fluid in the lower hydraulic chamber is released in a high velocity spray in an, e.g., cone pattern. The piezoelectric actuator is pre-stressed in the calibration of the injector, prior to actuation. If desired, the spray pattern may be a pulsed pattern, rather than a continuous pattern. Matching the frequency of the restraining force with the frequency of the piezoelectric actuator increases the degree of control of the valve and of the spray pattern.

The liquid injector of the present invention provides an accurate, finely controlled spray pattern. In an engine, the liquid injectors make good fuel injectors, providing accurate ratios of mixing of fuel and compressed air, and a high velocity spray which improved atomization of the fuel, and mixing with the air.

For a full understanding of the present invention, reference should now be made to the following detailed description of the preferred embodiments of the invention as illustrated in the accompanying drawings.

### BRIEF DESCRIPTION OF THE DRAWINGS

The present invention will be further described with reference to the accompanying drawings, wherein like reference numerals refer to like parts in the several views, and wherein:

FIG. 1 depicts a cross-section of an exemplary embodiment of a fuel injector in an open/spray position according to one aspect of the present invention.

FIG. 2 depicts a cross-section of an exemplary embodiment of a fuel injector in a closed position according to another aspect of the present invention.

FIG. 3 depicts a cross section of an upper body detail of the exemplary embodiments shown in FIGS. 1 and 2 according to yet another aspect of the present invention.

FIG. 4 depicts a block diagram for an exemplary embodiment of a liquid injector control system according to still another aspect of the present invention.

FIG. 5 depicts a block diagram of an exemplary embodiment of a fuel delivery system according to yet another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

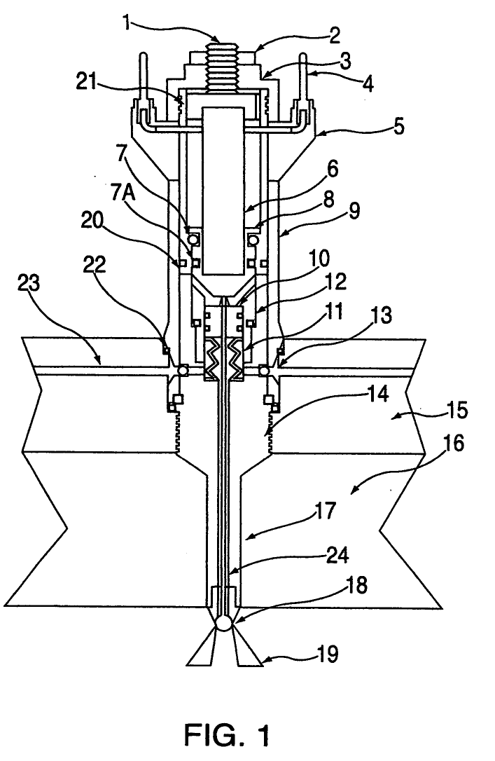

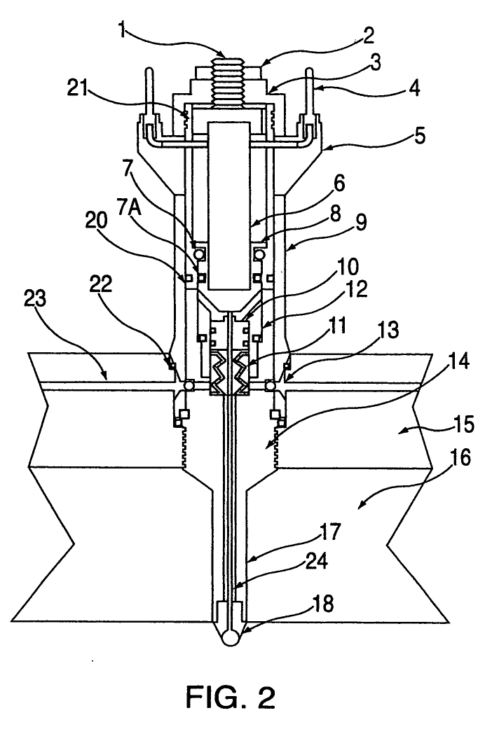

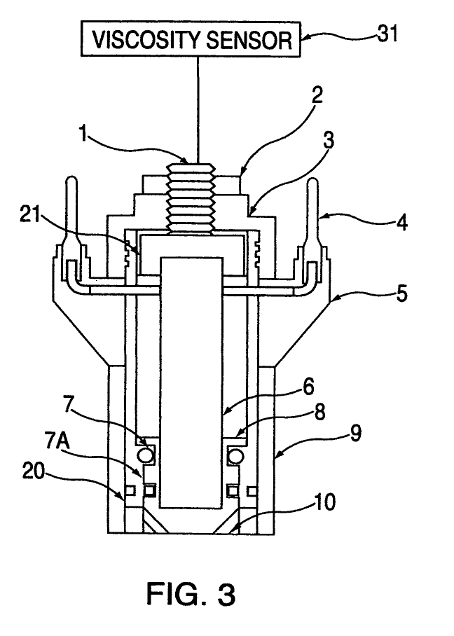

An exemplary embodiment of the present invention will now be described with reference to FIGS. 1 to 5 of the drawings. Identical elements in the various figures are designated with the same reference numerals.

A Piezo stack actuator works much like a spring. It is built of many layers like the coils on a spring. Each layer expands a given rate if voltage is applied to the crystal. Each layer on a Piezo actuator expands anywhere from 50 nanometers to 200 nanometers, depending on the material. In order to create a Piezo stack actuator with a travel of 40 micrometers; if the base crystal has an expansion of 200 nanometers, 200 layers are needed. Like a spring, if its compressed it has a lot of force; but the more it extends itself it looses force exponentially. If each Piezo layer has a expansion force of 10N the total starting force of the Piezo actuator is 2000N. But as it expands it loses 10N in force for every 200 nanometer of expansion. Therefore, if the actuator with a total travel of 40 microns and a total force of 2000N has expanded to 20 micron, the total available force at that point is only 1000N.

A Piezo actuator expands proportionally to the voltage applied; e.g., if it's a 150V Piezo actuator with a total travel of 30 microns it will expand 10 microns if we apply 50 volts, and 20 microns if we apply 100 volt.

Each Piezo stack actuator is rated (based on materials and construction) at a given resonant frequency. This is the highest frequency it can sustain. It is recommended to run Piezo stack actuators when fully loaded at no more than ⅓ of their resonant frequency.

For example, if a Piezo stack actuator has a resonant frequency of 30 Kilohertz (which means it can cycle 30,000 times per second) it should be operated at no more than 10 Kilohertz (10,000 cycles per second).

A Piezo stack actuator can expand under no load equal to the voltage applied; e.g., if we have a voltage rise of 50 nanoseconds from 0 to 150 volt a 150-volt actuator will fully expand at that rate. The minimizing factor on a stack is the internal harmonic between the individual layers and the way it is glued together.

If a load is applied, the expansion time will decrease based on the load applied much like a spring. In order to reach a given frequency, the actuator has to have a given force based on the load.

The piezoelectric liquid injector of the present invention was designed using these principles; giving it the ability to dispense fuel in very small high frequency bursts.

The injector shown in FIGS. 1-3, containing the numbered parts listed below, functions as follows:
1 CALIBRATION SCREW
2 COUNTER NUT
3 RETAINING CAP
4 ELECTRICAL PIN CONNECTOR
5 ELECTRICAL PIN RETAINER
6 PIEZO STACK ACTUATOR
7 PIEZO SEALS
7A PIEZO SEALS
8 UPPER ACTUATOR PISTON
9 OUTER FUEL INJECTOR SLEEVE
10 UPPER NEEDLE (FUEL COMPRESSION) PISTON
11 VALVE CLOSING SPRING
12 INNER VALVE PISTON SLEEVE
13 FUEL CHECK VALVE
14 MAIN FUEL INJECTOR BODY
15 FUEL RAIL
16 ENGINE HEAD
17 LOWER FUEL INJECTOR
18 VALVE SEAT WITH NEEDLE GUIDE AND FUEL PORTS
19 FUEL SPRAY
20 UPPER FUEL INLETS
21 PIEZO END CAP
22 SEALS
23 FUEL PORT
24 VALVE NEEDLE WITH BALL END
31 VISCOSITY SENSOR

A Piezo stack actuator 6 pushes against the upper actuator piston 8. This piston 8 touches the upper surface of the injector needle valve 24, which is held in the closed position by the closing spring 11.

There is fuel between the upper actuator piston 8 and the upper valve needle piston 10.

As the Piezo stack actuator 6 expands it pushes immediately against the needle valve 24, and the valve starts to open. At the same time the fuel in between the upper actuator piston 8 and the upper needle piston 10 is sealed by the fuel check valve 13, and compressed, and acts like a hydraulic transmission increasing the opening distance and speed by the factor of piston size; e.g., if the actuator piston 8 has a diameter of twelve (12) mm and the needle piston 10 has a diameter of four (4) mm. it creates a three-to-one (3:1) transmission in travel and speed. For example, as the Piezo stack actuator 6 moves the upper actuator piston 8 thirty (30) microns the needle valve should travel ninety (90) microns via the hydraulic transmission. Fluid compressibility (approximately 1% per 1000 PSI) will reduce the actual travel to about eighty-one (81) microns.

The fuel enters from the fuel rail 15 at a pressure of eighty-five (85) PSI and equalizes pressure throughout the fuel injector. The fuel enters the injector thru two small holes in the sleeve 9, between the upper actuator piston 8 and the upper needle piston 10, where the fuel is used as a transmission fluid. The fuel also enters thru the fuel check valve 13.

The valve needle 24 has a ball end (actual valve body) a needle stem and an upper piston 10. The ball end seats into the valve seat 18 and the closing spring 11 pushes against the upper needle piston 10 holding the valve closed. The fuel pressure against the valve seat 18 is a constant eighty-five (85) PSI.

As the injector is actuated the upper actuator piston 8 pushes (first mechanically and then hydraulically) against the upper needle piston 10. The needle valve 24 moves down against the spring force of the closing spring 11 and opens the valve by unseating the ball end from the valve seat 18. At the same time the lower surface of the upper needle piston 10 compresses the fuel and forces it out of the opening created by the unseating of the valve 24. There is an increase in pressure across the valve opening by a ratio of valve opening surface to upper needle piston surface. So, for example, if the upper needle piston surface is 10 square-millimeters and the opening is 0.1 square-millimeters we have a pressure increase of 1:100, which means the fuel exit pressure rises momentarily from 85 PSI to 8500 PSI. The pressure on the initial opening has a compression factor of 285:1. Thus, the initial opening starts at 0.035 square-millimeters at a pressure burst of 24,000 PSI, decreasing exponentially as the valve opens further and settling at 85 PSI at full open and return stroke.

The rapid rise in pressure may be used to create many high pressure bursts to break up the fuel particles and create even dispersion into the air.

The Piezo actuator disburses an exact amount of fuel in a high pressure burst at every stroke.

The fuel injector Piezo stack is designed to have a resonant frequency of 36 kilohertz and a force of 6500N and may be operated at a frequency of 12 kilohertz.

The forces of the closing spring 11 and the Piezo actuator 6 oppose each other. The highest resonance frequency of a spring is based on the load applied, the travel required and the force of the spring. In order to have a closing spring with a high enough force and frequency, a Belleville spring stack was selected as the closing spring 11. The preferred fuel injector uses eight Belleville spring discs with a force of 80 N each and a total travel of 30 microns each yielding a total travel of 240 microns and a total closing force of 640 N. Based on the load (weight of the needle, seal friction, upper fluid weight and actuator piston) a resonant spring frequency of 10 kilohertz may be achieved.

When the engine runs at 2000 RPM on a two-stroke cycle (7.5 milliseconds/stroke) all the fuel must be injected in about 5 milliseconds. At 10 kilohertz the injector of the present invention can inject 50 spurts of fuel per single stroke of the piston.

At lower speeds even more spurts per cycle may be achieved. To inject a smaller amount of fuel the voltage to the Piezo actuator may be changed, so that the needle valve 24 travels a smaller distance dispersing less fuel. This injector is a positive displacement injector because it is based on the travel of the valve 24. The injector can mechanically break up all the fuel into micro particles to be easily absorbed into the air to create an air/fuel mixture, which is easily lit.

For the injector to work for multi-fuels a sensor 31 detects the viscosity of the given fuel and adjusts the injector timing based on the reading.

The injector is designed to screw into a fuel rail 15 on top of the engine. The incoming fuel is sealed off with two O-rings next to the fuel inlet port 23.

The fuel injector is easily calibrated with a screw 1 pressing via cap 3 against the Piezo actuator 6 and the needle valve 24. The screw 1 can be secured in its final setting by a counter nut 2.

The injector can be plugged into an electronic control board with its upper pin connector.

Controlling the injector requires a power source of 150 VDC. The applied voltage is regulated by a digital-to-analog 0-150 volt regulator that is adjusted by the digital signal processor (DSP). A solid-state relay switches the power to the Piezo on and off. The circuit has to switch to a fast ground every time the Piezo is turned off because the Piezo reacts like a capacitor and only retracts after bleeding the voltage to ground. The DSP has to toggle the ground. To control the injector the following is required:
Digital signal processor
Power source (e.g., battery)
Power converter 12-150 Volt
Digital-to-analog voltage regulator 0-150 Volt
Three (3) solid-state relays

The DSP generates the high frequency outputs, requiring fast switching speeds for the solid-state relays. The fuel injector produces a pulsing cone pattern. This pattern gives the best mixing effect for fuel atomization and absorption of the fuel into the air stream. The spray pattern can be changed in the fuel injector. It is based on the valve shape so the fuel injector valve has to match the combustion chamber design. For example the valve can be designed to create a spray to one side only up to a given opening valve travel and then change to a full cone once the valve opens further. So basically many spray patterns are possible and the pattern may be adjusted based on the combustion chamber design. The drawing below is a rendering of a version of this injector.

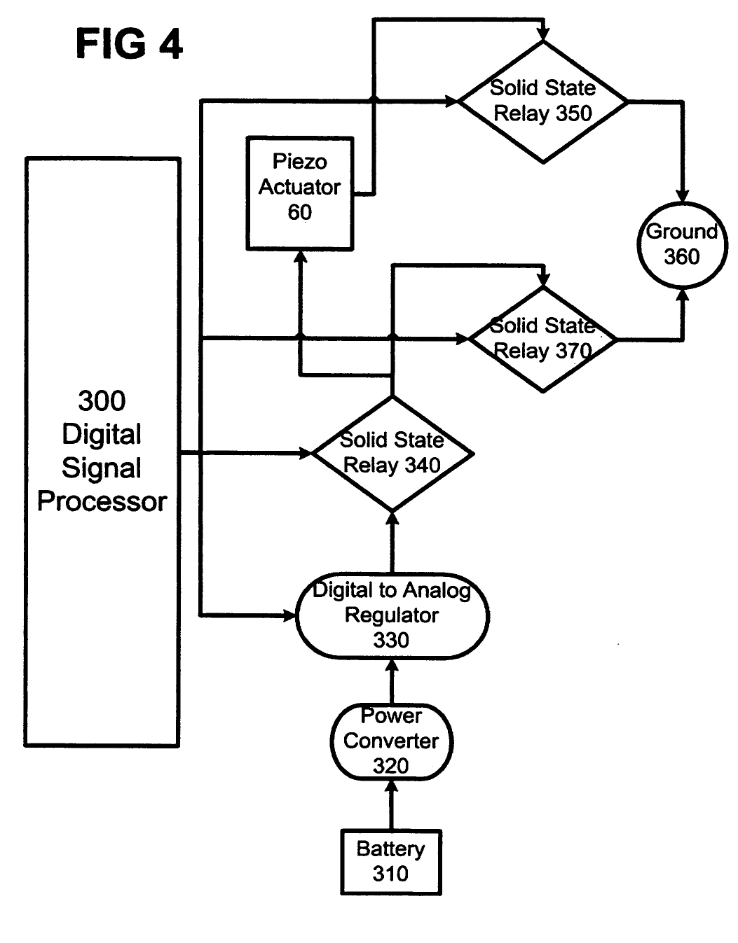

Referring to FIG. 4, the operation of the present invention is controlled by a Digital Signal Processor (DSP) 300 although it is envisioned that other means of mechanical or electrical control known in the art could be used for control.

Power to the injector is provided from a power source, such as a battery 310. A power converter 320 converts the source voltage to an acceptable voltage range for the piezo actuator 60, preferably 0-150 VDC. The applied voltage is regulated by a digital-to-analog regulator 330, also controlled by the DSP 300. The magnitude of the actual voltage is determined by the DSP 300 based on the fuel requirements.

To actuate the piezo actuator 60 the DSP 300 provides a gate signal to the power switching relay 340 and to the ground switching relay 350 supplying both power and ground 360 to the piezo actuator 60. The DSP 300 turns off the piezo actuator 60 by removing the gate signal from the power-switching relay 340 and the ground-switching relay 350. The DSP 300 then applies a gate signal to the grounding relay 370 shorting the piezo actuator 60 to ground 360 in order to drain any stored energy in the piezo actuator 60. The gate to the grounding relay 370 is then removed.

The expansion and retraction happens in a very short time; i.e., it happens simultaneously with the voltage wave. If the Piezo is grounded to make it retract it will do so in about 20-50 microseconds. This fast retraction or expansion puts a lot of stress on the glue joints of the actuator. So pre-stressing the actuator prevents delaminating of the actuator and extends its lifetime.

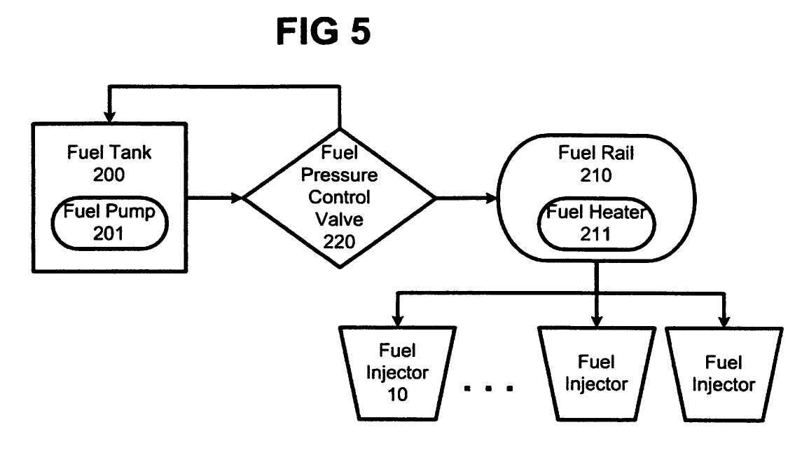

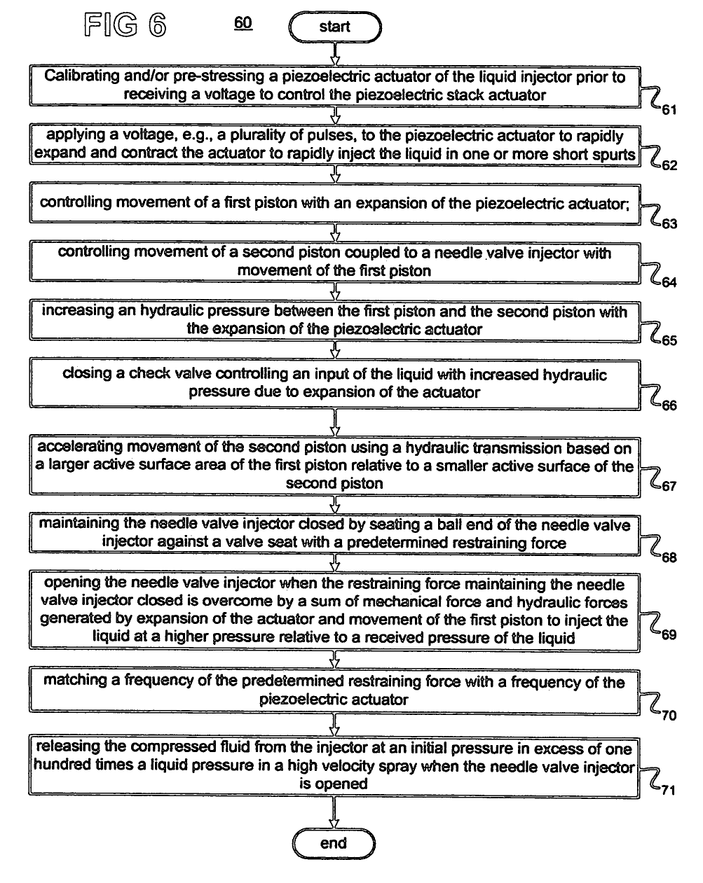

Referring to FIG. 5, fuel is stored at or near ambient pressure within the fuel tank 200. The fuel pump 201 delivers pressurized fuel to the fuel rail 210. Fuel is heated in the fuel heater 211 to the desired fuel delivery temperature. Fuel is pressurized by both the fuel pump 201 and by the heating of the fuel by the fuel heater 211. Rail pressure is regulated by the fuel pressure control valve 220.

In the present invention, fuel is delivered from the fuel rail 210 to the injector 10 at relatively low pressure, e.g. 5.8 bar, or 85 psi. This initial pressurization of the liquid both pre-compresses the liquid and pre-stresses the piezo actuator 60. The piezo actuator 60 is pre-stressed by both the upper compression seal 7 and the pressurized fluid in the upper hydraulic chamber. Pre-stressing of the piezo actuator and pre-compressing the fuel allows the piezo actuator to rapidly compress the fuel.

There are two seals, 7 and 7A, around the upper actuator piston and these seals 7, 7A protect the Piezo from the fuel. The lower seal 7A is a moving O-ring and the upper seal 7 is a compression O-ring. Every time the Piezo expands the O-ring is compressed. This O-ring is also used to pre-stress the Piezo element. A softer Viton rubber is used for this seal. This rubber has a very high resonance rate. The Piezo actuator expands only 60 microns so the compression during Piezo actuation is very small.

Unlike the prior art, the current invention atomizes liquid without high pressurization. Instead, atomization of the liquid and mixing of the fuel and air within the combustion chamber is achieved by rapid compression of the fuel within the injector and simultaneously injecting the liquid at high velocity into the combustion chamber.

Fuel is stored at ambient pressure within the fuel tank. The fuel pump delivers pressurized fuel to the fuel rail. Within the fuel rail, the fuel is heated by the fuel heater to the desired fuel delivery temperature. Fuel is pressurized by both the fuel pump and the fuel heater. Rail pressure is regulated by the fuel pressure control valve and excessive pressure is relieved by returning fuel to the fuel tank.

Fuel is delivered from the fuel rail to the injector at 5.8 bar, or 85 psi. This initial pressurization of the liquid both pre-compresses the liquid and pre-stresses the piezo actuator, which allows the piezo actuator to rapidly compress the fuel. In addition to hydraulically compressing the fuel, the piezo actuator, which is in mechanical communication with the injector needle, unseats the needle valve. The simultaneous compression and injection of the fluid raises the fuel pressure within the injector above the internal pressure in the combustion chamber and injects the fuel at high velocity into the combustion chamber. Because the fuel is injected at a slightly higher pressure than the pressure within the combustion chamber, preferably 30 bar, or 425 psi, the injected fuel can move freely within the compressed gas in the combustion chamber. The high velocity atomizes the fuel and induces mixing of the fuel with the compressed air.

Fuel is only injected at high velocity during the period of expansion of the piezo electric. During the expansion of the piezo actuator only a portion of the required fuel volume is injected into the combustion chamber, therefore the piezo electric must be rapidly fired with high frequency pulses. The pulsing of the fluid helps the turbulence inside the chamber and increases molecular absorption (mixing) of the fuel into (with) the gas creating a more even fuel air mixture.

The rise time of the voltage driving the piezo actuator is critical to the proper operation of the present invention. This is because the rate of expansion of the piezo actuator determines the velocity of the fuel. Each voltage pulse delivers a pulse of high velocity fuel into the combustion chamber. The volume of each pulse is equal to a fraction of the required injection.

Turning to FIG. 6, shown therein is an exemplary embodiment of a method 60 for injecting a liquid, such as fuel using one or more of the exemplary embodiments described above, according to another aspect of the present invention.

In element 61, initially, an electronically controlled actuator (e.g., a piezoelectric stack actuator) in a liquid injector may be calibrated to place some predetermined stress on the actuator. In addition, the actuator may be further pre-stressed using compression of the liquid and/or an outer compression ring, such as an O-ring. This calibration and pre-stressing would typically occur prior to receiving a voltage to control or initiate actuation of the piezoelectric stack actuator.

In element 62, a voltage signal is applied to the actuator. For example, the voltage signal could comprise a plurality of pulses with steep pulse edges, which is applied to the piezoelectric actuator to rapidly expand and contract the actuator and therefore to rapidly inject the liquid in one or more short spurts. As the pressure of the spurts is highest at the initial injection, using several short spurts as opposed to one long burst will increase the atomization of the fuel, as described above.

In element 63, movement of a first piston is controlled with an expansion of the piezoelectric actuator. The first piston could comprise the upper actuator piston 8 in FIGS. 1-3.

In element 64, movement of a second piston coupled to a needle valve injector is controlled with movement of the first piston. The second piston could comprise the upper needle piston 10 shown in FIGS. 1-3.

In element 65, an hydraulic pressure between the first piston and the second piston is increased due to expansion of the piezoelectric actuator. Expanding the actuator increases the pressure on the liquid inside the injector.

In element 66, a check valve controlling an input of the liquid is closed due to increased hydraulic pressure resulting from expansion of the actuator.

In element 67, movement of the second piston is accelerated using a hydraulic transmission based on a larger active surface area of the first piston relative to a smaller active surface of the second piston, as was described above.

In element 68, the needle valve injector is maintained closed by seating a ball end of the needle valve injector against a valve seat with a predetermined restraining force.

In element 69, the needle valve injector is opened when the restraining force maintaining the needle valve injector closed is overcome by a sum of mechanical force and hydraulic forces generated by expansion of the actuator and movement of the first piston to inject the liquid at a higher pressure relative to a received pressure of the liquid, as has been described above.

In element 70, a frequency of the predetermined restraining force is matched with a frequency of the piezoelectric actuator. For example, the frequency of the spring is matched with the frequency of the expansion of the actuator to achieve optimal results.

In element 71, the compressed fluid is released from the injector at an initial pressure in excess of one hundred times a liquid pressure in a high velocity spray when the needle valve injector is opened.

While the above exemplary embodiment of a method for injecting the liquid includes multiple steps, not all steps are necessary to practice the present invention. In other words, some steps are optional without departing from the scope of the present invention. Moreover, the order of the steps in the method is not important, other than those steps that specifically require a prior step to be performed.

There has thus been shown and described a novel liquid injector device which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention.

What is claimed is:

1. An apparatus for controllably injecting a liquid comprising:
a housing including an inlet port to accept the liquid at a first pressure;
an injector to inject the liquid when actuated;
an electronically controlled actuator to actuate the injector; and
a fluid controller to open and close the inlet port, said fluid controller to close the inlet port when the electronically controlled actuator begins actuation of the injector, wherein said electronically controlled actuator increases a pressure of the liquid within the housing at which time the fluid controller closes the inlet port, resulting in a pressure increase of the liquid from the first pressure to a second pressure, and said liquid is injected by said injector at a pressure at least equal to the second pressure, which is equal to or higher than a pressure into which the liquid is injected.

2. The apparatus according to claim 1, wherein said electronically controlled actuator comprises a piezoelectric actuator that expands upon being activated with a voltage.

3. The apparatus according to claim 1, wherein said fluid controller comprises a check valve disposed near an entrance of the inlet port to the housing, said check valve to maintain the inlet port open until the electronically controlled actuator begins actuating the injector, at which time the check valve closes the inlet port, and said electronically controlled actuator increases a pressure of the liquid in the housing prior to injecting the liquid.

4. The apparatus according to claim 3, wherein the electronically controlled actuator comprises a piezoelectric actuator that expands when activated with a voltage, which expansion increases pressure on the liquid, which closes the check valve.

5. The apparatus according to claim 1, wherein the injector comprises:
a needle valve to inject the liquid when actuated by the electronically controlled actuator;
a needle valve piston mechanically coupled to the needle valve; and
an hydraulic acceleration piston mechanically and hydraulically coupled to the needle valve piston and mechanically coupled to the electronically controlled actuator.

6. The apparatus according to claim 5, wherein the electronically controlled actuator comprises:
a piezoelectric stack actuator including a voltage input to receive a voltage signal and being mechanically coupled to the hydraulic acceleration piston, said piezoelectric stack actuator to actuate the needle valve by expansion initiated by the received voltage signal, which expansion initiates closure by the fluid controller of the inlet port, moves the hydraulic acceleration piston, increases hydraulic pressure between the needle valve piston and the hydraulic acceleration piston, which increased hydraulic pressure accelerates movement of the needle valve piston and opening of the needle valve to inject the liquid at or above the second pressure.

7. The apparatus according to claim 5, further comprising:
a restraining mechanism mechanically coupled to the needle valve piston to maintain the needle valve in a closed position until a force exceeding a restraining force generated by the restraining mechanism is generated on the needle valve piston.

8. The apparatus according to claim 7, further comprising a valve seat, wherein said restraining mechanism comprises:
a spring to generate the restraining force and coupled to the needle valve piston, said needle valve including one end resting against the valve seat and another end mechanically coupled to the needle valve piston and to the hydraulic acceleration piston, and maintained closed until the force generated on the needle valve piston exceeds the restraining force.

9. The apparatus according to claim 1, further comprising:
a sensor coupled to the electronically controlled actuator to detect a viscosity of the liquid and to adjust timing to accommodate a particular liquid from among a plurality of liquids.

10. The apparatus according to claim 9, wherein said plurality of liquids includes one or more of the following liquids alone or in combination: fuel, diesel fuel, gasoline, ethanol, alcohol, JP5 fuel and JP8 fuel.

11. The apparatus according to claim 2, wherein said piezoelectric actuator can accept a voltage signal in a range from zero volts up to approximately 150 volts having a frequency from zero to approximately thirty-six kilohertz.

12. The apparatus according to claim 1, wherein said first pressure comprises between a value up to about 85 psi and the second pressure comprises an initial value of at least about 425 psi or greater.

13. The apparatus according to claim 1, wherein the liquid is injected from the injector at an initial pressure value more than approximately between one hundred and three hundred times the first pressure.

14. The apparatus according to claim 5, wherein the electronically controlled actuator comprises a piezoelectric stack actuator, and said apparatus further comprises:
an upper seal; and
a lower seal, both the upper and lower seals being disposed around the first piston to protect the piezoelectric stack actuator from the liquid.

15. The apparatus according to claim 14, wherein the lower seal comprises a moving O-ring and the upper seal comprises a compression O-ring, when the piezoelectric actuator expands the compression O-ring is compressed, and said compression O-ring pre-stresses the piezoelectric stack actuator.

16. A method for injecting a liquid comprising:
controlling movement of a first piston with an expansion of a piezoelectric actuator;
controlling movement of a second piston coupled to a needle valve injector with movement of the first piston;
increasing an hydraulic pressure between the first piston and the second piston with the expansion of the actuator;
opening the needle valve injector when a predetermined restraining force maintaining the needle valve injector closed is overcome by a sum of a mechanical force and a hydraulic force generated by expansion of the actuator and movement of the first piston to inject the liquid at a higher pressure relative to a pressure of the liquid when received.

17. The method according to claim 16, further comprising:
accelerating movement of the second piston using a hydraulic transmission based on a larger active surface area of the first piston relative to a smaller active surface of the second piston.

18. The method according to claim 16, further comprising:
applying a pulsed voltage including a plurality of pulses to the piezoelectric actuator to rapidly expand and contract said actuator to rapidly inject the liquid in a plurality of short spurts.

19. The method according to claim 16, further comprising:
closing a check valve controlling an input of the liquid with increased hydraulic pressure due to expansion of the actuator.

20. The method according to claim 16, further comprising:
maintaining the needle valve injector closed by seating a ball end of the needle valve injector against a valve seat with the predetermined restraining force.

21. The method according to claim 16, further comprising:
releasing the compressed fluid from the injector at an initial pressure in excess of one hundred times a liquid pressure in a high velocity spray when the needle valve injector is opened.

22. The method according to claim 18, further comprising:
pre-stressing the piezoelectric actuator prior to receiving the voltage to expand the actuator.

23. The method according to claim 20, further comprising:
matching a frequency of the predetermined restraining force with a frequency of the piezoelectric actuator.

24. An apparatus for controlling a liquid injector comprising:
a voltage source to generate a voltage signal;
a power converter coupled to the voltage source to convert the voltage signal output by the voltage source to a converted voltage signal within a predetermined voltage range;
a voltage regulator coupled to the power converter to create an applied voltage signal having an adjustable magnitude, said voltage regulator including a control input to receive a control signal that determines a value of the magnitude of the applied voltage signal output by the voltage regulator;
a solid-state relay circuit to be coupled to the liquid injector to switch a fast ground when turning off the liquid injector; and
a processor including a first output coupled to the voltage regulator, and a second output coupled to the solid-state relay circuit, said processor to toggle a ground signal and to generate one or more high frequency gate signals to control the solid-state relay circuit and to generate a control signal to control a magnitude of the applied voltage signal output by the voltage regulator based on at least a liquid requirement.

25. The apparatus according to claim 24, where said solid-state relay circuit further comprises:
a ground connection;
a power switching relay including a first gate input coupled to the second output of the processor to receive a first gate activation signal from the processor, a first voltage input coupled to the voltage regulator to receive the applied voltage signal and a first voltage output to be coupled to a power input of the liquid injector via which to output the applied voltage signal upon receiving the first gate activation signal from the processor via the first gate input;
a ground switching relay including a second gate input coupled to the second output of the processor to receive the first gate activation signal from the processor, a first ground input to be coupled to a ground of the liquid injector and a first ground output to be coupled to said ground connection upon receiving the first gate activation signal from the processor via the second gate input; and
a grounding relay having a third gate input to receive a second gate activation signal, a voltage input to be coupled to the power input of the liquid injector and a second ground output to couple the power input of the liquid injector to said ground connection upon receiving the second gate activation signal from the processor via the third gate input.

26. The apparatus according to claim 25, wherein:
to actuate the liquid injector, said processor provides a first gate activation signal to the power switching relay and to the ground switching relay to supply both the applied voltage signal and the ground connection to the liquid injector; and
to turn off the liquid injector, said processor removes the first gate signal from the power-switching relay and the ground-switching relay, then said processor applies a second gate signal to the third gate input of the grounding relay to short the liquid injector to the ground connection to drain any stored energy in the liquid injector, after which the second gate signal to the third gate input of the grounding relay is then removed.

27. An apparatus for injecting a liquid comprising:
a tank to store the liquid at or near an ambient pressure, said tank including a pump to pump the liquid out of the tank at a first pressure;
one or more injectors, each to inject the liquid;
a pressure control valve coupled to the pump;
a liquid rail receiving the liquid output by the pump via the pressure control valve supplying the liquid to each of the one or more liquid injectors, said pressure control valve to regulate a pressure in the liquid rail; and
a heater disposed in the liquid rail to heat the liquid to a predetermined temperature and to thereby raise a pressure of the liquid from the first pressure to a second pressure higher than the first pressure;
wherein each of said one or more liquid injectors injects the liquid at a third pressure higher than the second pressure, each receiving the liquid at the second pressure, which pre-stresses said each the liquid injector enabling the liquid injector to rapidly compress the liquid prior to injecting the liquid at the third pressure.
